(19) United States
(12) Patent Application Publication
(10) Pub. No.: US 2024/0158643 A1
(43) Pub. Date: May 16, 2024

(54) OPTICAL COATING MATERIAL, OPTICAL FILM AND OPTICAL SUBSTRATE

(71) Applicant: NAN YA PLASTICS CORPORATION, TAIPEI (TW)

(72) Inventors: Te-Chao Liao, TAIPEI (TW); Chun-Che Tsao, TAIPEI (TW); Yi-Chen Chou, TAIPEI (TW)

(73) Assignee: NAN YA PLASTICS CORPORATION, TAIPEI (TW)

(21) Appl. No.: 18/154,007

(22) Filed: Jan. 12, 2023

(30) Foreign Application Priority Data
Nov. 11, 2022 (TW) 111143215

(51) Int. Cl. C09D 4/06; C09D 7/20; C09D 7/40; C09D 7/47; C09D 7/61; C09D 135/02

(52) U.S. Cl. CPC C09D 4/06; C09D 7/20; C09D 7/47; C09D 7/61; C09D 7/67; C09D 135/02

(57) ABSTRACT

An optical coating material, an optical film and an optical substrate are provided. The optical coating material includes 15 wt % to 40 wt % of resin, 1 wt % to 10 wt % of nano-dispersion solution and 40 wt % to 70 wt % of organic solvent. The resin is at least one selected from a group consisting of polyurethane acrylate resin, epoxy resin, acrylate resin and acrylic polyol resin. The nano-dispersion solution includes nanoparticles. The nanoparticles includes aluminum oxide, zirconium oxide, titanium oxide or silicon oxide.

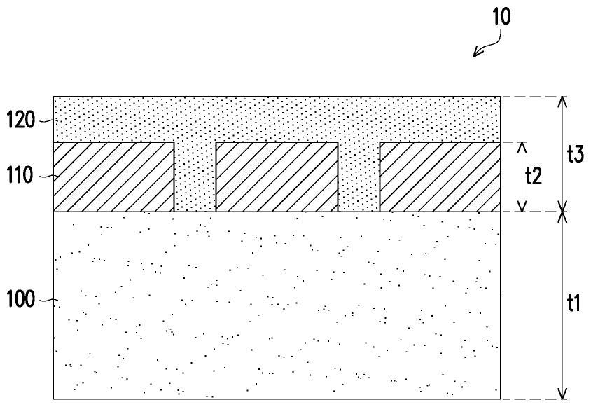

### CROSS-REFERENCE TO RELATED APPLICATION

This application claims the priority benefit of Taiwan application serial no. 111143215, filed on Nov. 11, 2022. The entirety of the above-mentioned patent application is hereby incorporated by reference herein and made a part of this specification.

### BACKGROUND

### Technical Field

The present invention relates to a coating material, a film and a substrate, and especially relates to an optical coating material, an optical film and an optical substrate.

### Description of Related Art

Generally speaking, a conductive glass is a glass coated with a transparent conductive layer on the surface of the glass to make it both transparent and conductive, so it is widely used in display, touch panel, solar cell and other fields. However, when the light passes through the conductive glass, interference phenomena may occurred due to passing through the pattern of the transparent conductive layer, so that the traces of the transparent conductive pattern may be shown. Accordingly, the undesired pattern may be generated when the conductive glass is applied to the product, and the product quality will be reduced. Therefore, how to reduce the pattern due to the interference phenomenon of the conductive glass is a problem to be solved at present.

### SUMMARY

The present invention provides an optical coating material, an optical film and an optical substrate, which have high transparency, high hardness, high refractive index and good adhesion.

The optical coating material of the present invention includes 15% by weight (wt %) to 40% by weight of a resin, 1% by weight to 10% by weight of a nano-dispersion solution and 40% by weight to 70% by weight of an organic solvent. The resin is at least one selected from a group consisting of a polyurethane acrylate resin, an epoxy resin, an acrylate resin and an acrylic polyol resin. The nano-dispersion solution includes nanoparticles, and the nanoparticles include aluminum oxide (Al₂O₃), zirconium oxide, titanium oxide or silicon dioxide.

In one embodiment of the present invention, the aforementioned polyurethane acrylate resin includes aliphatic polyurethane acrylates or aromatic polyurethane acrylates.

In an embodiment of the present invention, the aforementioned epoxy resin includes a cycloaliphatic epoxy resin or a carboxyl group epoxy resin.

In an embodiment of the present invention, the above-mentioned acrylate resin includes bisphenol A modified acrylate resins.

In one embodiment of the present invention, the above-mentioned optical coating material further includes 1% by weight to 10% by weight of a photoinitiator and 0.1% by weight to 1% by weight of a leveling agent.

In an embodiment of the present invention, the above-mentioned organic solvent is selected from a group consisting of methyl ethyl ketone, propylene glycol methyl ether acetate, propylene glycol monomethyl ether, methyl isobutyl ketone, ethyl acetate and toluene.

The optical film of the present invention is formed by the above-mentioned optical coating material.

In an embodiment of the present invention, the above-mentioned optical film has a refractive index between 1.63 and 1.67.

The optical substrate of the present invention includes a substrate, a conductive layer and the above-mentioned optical film. The conductive layer is disposed on the substrate, and the optical film covers the conductive layer and the substrate.

In an embodiment of the present invention, a material of the above-mentioned conductive layer includes indium tin oxide, gallium-doped zinc oxide, aluminum-doped zinc oxide or poly(3,4-ethylenedioxythiophene) polystyrene sulfonate.

Based on the above, the optical coating material of the present invention includes 15% to 40% by weight of a resin, 1% to 10% by weight of a nano-dispersion solution and 40% to 70% by weight of an organic solvent, wherein the resin is at least one selected from a group consisting of polyurethane acrylate resin, epoxy resin, acrylate resin and acrylic polyol resin, and the nanoparticles of nano-dispersion solution include aluminum oxide, zirconium oxide, titanium oxide or silicon dioxide, so it can form an optical film with high transparency, high hardness, high refractive index and good adhesion. When the optical film is disposed in the optical substrate, since the optical film has a high refractive index, the difference in the refractive index between the optical film and the underlying material becomes smaller with good optical matching, thereby avoiding the interference or diffraction caused by the optical path difference and improving the quality of the optical substrate.

### BRIEF DESCRIPTION OF THE DRAWINGS

FIGURE is a schematic diagram of an optical substrate according to an embodiment of the present invention.

### DESCRIPTION OF THE EMBODIMENTS

Hereinafter, the embodiment of the present invention will be described in detail. However, these embodiments are exemplary and the present invention disclosure is not limited thereto.

In an embodiment of the present invention, the optical coating material is used to form an optical film with high transparency, high hardness, high refractive index and good adhesion. The optical coating material includes 15% to 40% by weight of a resin, 1% to 10% by weight of a nano-dispersion solution and 40% to 70% by weight of an organic solvent. In some embodiments, the optical coating material also includes a photoinitiator and a leveling agent.

Resin

The resin is the main body of the optical coating material, which can be at least one selected from a group consisting of a polyurethane acrylate resin, an epoxy resin, an acrylate resin and an acrylic polyol resin. For example, the resin may consist of a polyurethane acrylate resin and an acrylate resin. In other embodiments, the resin may consist of acrylate resins, which is not limited thereto. The composition of the resin can be selected from the above-mentioned group in an appropriate combination and ratio according to actual needs (such as hardness, refractive index and etc.).

The polyurethane acrylate resin is a resin including urethane groups and acrylic groups. For example, the polyurethane acrylate resin includes aliphatic polyurethane acrylates, aromatic polyurethane acrylates, or other suitable polyurethane acrylates. In some embodiments, the polyurethane acrylate resin is synthesized from aliphatic isocyanates or aromatic isocyanates with polyols and acrylates. The aliphatic isocyanates include, for example, 1,6-hexamethylene diisocyanate (HDI), isophorone diisocyanate (IPDI), 4,4′-methylenebis (cyclohexyl isocyanate) (HMDI), cyclohexane diisocyanate (CHDI) or mixtures of the aforementioned materials, or other suitable aliphatic isocyanates. The aromatic isocyanates include, for example, toluene diisocyanate (TDI), methylene diphenyl diisocyanate (MDI), p-phenylene diisocyanate (PPDI), naphthalene diisocyanate (NDI), 3,3′-dimethyl-4,4′-biphenylene diisocyanate (TODI) or mixtures of the aforementioned materials, or other suitable aromatic isocyanates. The polyols may be polyether polyol, polyester polyol, polycarbonate polyol, polyurethane polyol or mixtures of the aforementioned materials, or other suitable polyols. However, the present invention is not limited thereto.

The epoxy resin includes, for example, cycloaliphatic epoxy resin, carboxyl group epoxy resin, or other suitable epoxy resins. Specifically, the carboxyl group epoxy resin is a resin having a carboxyl group and an epoxy group. The cycloaliphatic epoxy resin can be obtained by crosslinking cycloaliphatic epoxide monomers, such as 3, 4-epoxycyclohexylmethyl-(3, 4-epoxy) cyclohexanecarboxylate, dialicyclic diether diepoxy [2-(3,4-epoxy) cyclohexyl-5,5-spiro (3,4-epoxy)-cyclohexane-m-dioxane], bis (3, 4-epoxy-cyclohexylmethyl) hexyl diesters, bis (3,4-epoxy-cyclohexyl) adipate, poly[(2-oxiranyl)-1,2-cyclohexanediol] 2-ethyl-2-(hydroxymethyl)-1,3-propanediol ether or other suitable cycloaliphatic epoxide monomers, but the present invention is not limited thereto, and the cycloaliphatic epoxide monomers may include one or more selected from the group formed above.

The acrylate resin can be obtained by cross-linking acrylate monomers. The acrylate monomers, for examples, includes methyl acrylate, methyl methacrylate, ethyl acrylate, 2-ethylhexyl acrylate, butyl acrylate, butyl methacrylate, ethylhexyl acrylate or other suitable acrylate monomers, but the present invention is not limited thereto, and the acrylate monomers may include one or more selected from the group formed above.

In some embodiments, the acrylate resin can be bisphenol A modified acrylate resins.

The acrylic polyol resin is an amorphous polyol, which can be obtained by polymerizing hydroxyl group containing acrylates and non-hydroxyl group containing acrylates. The hydroxyl group containing acrylates include, for example, hydroxyethyl acrylate, hydroxypropyl acrylate, hydroxyethyl methacrylate, hydroxypropyl methacrylate or other suitable materials. However, the present invention is not limited thereto, and the hydroxyl group-containing acrylates may include one or more selected from the group formed above. The non-hydroxyl group containing acrylates may include, for example, materials similar to the above-mentioned acrylate monomers.

In this embodiment, the optical coating material contains about 15% to 40% by weight of the resin. In this way, the optical coating material can be provided with good film-forming properties, so that the formed optical film has good mechanical properties and transparency. If the resin content is less than 15% by weight, it may not be easy to form a film; if the resin content exceeds 40% by weight, the optical properties (such as transparency, refractive index and etc.) of the optical film formed by the optical coating material may be affected.

Nano-Dispersion Solution

The nano dispersion solution is used to increase the refractive index of the optical coating material. The nano-dispersion solution includes nanoparticles dispersed in a solvent. The nanoparticles include, for example, aluminum oxide, zirconium oxide, titanium oxide, silicon dioxide, or other suitable materials. The solvent of the nano-dispersion solution can be a solvent miscible with organic solvents, such as ethanol, isopropanol or the organic solvent in the optical coating material (referring to the succeeding description for detail), but the present invention is not limited thereto.

In some embodiments, the nanoparticles have an average particle size between 5 nm and 100 nm. In some embodiments, the nanoparticle solid content of the nano-dispersion solution is between 1% and 10% by weight.

In this embodiment, the optical coating material contains about 1% to 10% by weight of nano-dispersion solution to improve the refractive index of the optical film subsequently formed by the optical coating material. If the content of nano-dispersion solution is less than 1% by weight, the refractive index of the formed optical film may be insufficient; if the content of nano-dispersion solution exceeds 10% by weight, the transparency of the formed optical film may be affected and the manufacturing cost may be increased.

Photoinitiator

The photoinitiator is used to generate free radicals, cations or anions by being excited by absorbing light energy (such as ultraviolet light), so as to initiate a polymerization reaction. The photoinitiator may be one or more selected from a group consisting of phenylphosphine oxide, cyclohexyl phenyl ketone, methyl phenyl acetone, benzoin dimethyl ether and methyl phenylacetate. However, the present invention is not limited thereto.

In some embodiments, the optical coating material includes about 1% to 10% by weight of a photoinitiator. If the content of the photoinitiator is less than 1% by weight, the optical coating material may be difficult to cure or have poor curing efficiency; if the content of the photoinitiator exceeds 10% by weight, the curing reaction may be too fast, resulting in high shrinkage of the film layer, poor adhesion to the substrate, and residues of the resin monomer, such that the film layer may be easy to fall off or its mechanical properties may reduce, and manufacturing costs may increase.

Leveling Agent

The leveling agent is used to increase the fluidity of the optical coating material, so that the optical coating material can be evenly dispersed on the coated material and make the surface smooth. The leveling agent can be one or more selected from a group consisting of acrylate copolymers, modified phosphate esters, multi-acrylate functional groups modified polysiloxane, organosilicon acrylates and polyether polyester modified organosiloxane, but the present invention is not limited thereto.

In some embodiments, the optical coating material includes about 0.1% to 1% by weight of the leveling agent. If the content of the leveling agent is less than 0.1% by weight, it may be difficult for the optical coating material to achieve the leveling effect; if the leveling agent content exceeds 1% by weight, it may affect the uniformity of coating, and further affect the appearance, optical properties or mechanical properties of the optical film formed by the optical coating material.

Organic Solvent

The organic solvent is used to mix the above-mentioned solutes (including the resin, the nano-dispersion solution, the photoinitiator and the leveling agent) to facilitate the coating of the optical coating material. The organic solvent can be one or more selected from a group consisting of methyl ethyl ketone (MEK), propylene glycol methyl ether acetate (PMA), propylene glycol monomethyl ether (PM), methyl isobutyl ketone (MIBK), ethyl acetate (EAC) and toluene, but the present invention is not limited thereto.

In this embodiment, the optical coating material contains about 40% to 70% by weight of organic solvents to effectively mix all solutes uniformly.

The optical film of another embodiment of the present invention is formed by the above-mentioned optical coating material, which has high transparency, high hardness, high refractive index and good adhesion. In some embodiments, the optical film formed by the optical coating material described above has a refractive index between 1.63 and 1.67. In some embodiments, the optical film has a pencil hardness between 2H and 5H. In some embodiments, the visible light transmittance of the optical film is between 85% and 95%.

FIGURE is a schematic diagram of an optical substrate according to an embodiment of the present invention.

Referring to FIGURE, the optical substrate 10 includes a substrate 100, a conductive layer 110 and an optical film 120. The conductive layer 110 is disposed on the substrate 100. The optical film 120 covers the conductive layer 110 and the substrate 100.

The substrate 100 is a transparent substrate, for example, a glass substrate, a PET substrate or other suitable transparent substrates. In some embodiments, the thickness t1 of the substrate 100 may be between 0.3 mm and 3 mm, preferably between 0.3 mm and 0.5 mm.

The conductive layer 110 is a patterned conductive layer, which may include connection lines or circuit elements (not shown). The material of the conductive layer 110 can be a transparent conductive material, such as indium tin oxide (ITO), gallium-doped zinc oxide (GZO), aluminum-doped zinc oxide (AZO), poly(3,4-ethylenedioxythiophene) polystyrene sulfonate (PEDOT:PSS) or other suitable transparent conductive materials. FIGURE schematically shows a conductive layer, but it is not used to limit the present invention. The number of conductive layers and their wiring layout can be adjusted according to actual needs. In some embodiments, the thickness t2 of the conductive layer 110 may be between 0.1 μm and 2 μm, preferably between 1.5 μm and 2 μm.

The optical film 120 may be an optical film formed by the above-mentioned optical coating material. Specifically, the optical coating material can be coated on the substrate 100 and the conductive layer 110 by using the spin coating method. Subsequently, the optical coating material is dried and heated to remove the organic solvent therein, and then cured by ultraviolet rays to form an optical film 120. In some embodiments, the thickness t3 of the optical film 120 may be between 2 μm and 10 μm, preferably between 3 μm and 5 μm.

In some embodiments, the refractive index of the optical film 120 is between 1.63 and 1.67. In this way, when the optical substrate 10 is irradiated by sunlight or visible light, since the optical film 120 has a high refractive index, it has good optical matching, thereby avoiding the interference or diffraction caused by the optical path difference.

In some embodiments, the optical film 120 covers the surface of the conductive layer 110. That is, the conductive layer 110 will not be exposed. In addition, since the optical film 120 has high hardness, it can protect the conductive layer 110 and reduce its damage due to scratches.

In some embodiments, the optical substrate 100 is suitable for application in touch panel, display or solar cell.

The following experiments are listed to verify the efficacy of the present invention, but the present invention is not limited to the following content.

### Experimental Example 1

First, a glass substrate with ITO conductive layer was provided. Then, according to the formulation of Experimental Example 1 in Table 1, the optical coating material was mixed uniformly in the stirring container, and then the optical coating material was coated on the glass substrate with the ITO conductive layer by the spin coating method, wherein the rotational speed of the spin coating method is controlled at about 1000 to 2500 rpm, and the time is about 30 seconds to 90 seconds. Then, the substrate coated with the optical coating material is put into an oven at 100 degrees Celsius and bake for 30 seconds to 90 seconds to remove the solvent. After that, it is cured with ultraviolet light to obtain an optical film (or optical substrate), wherein the curing energy of the ultraviolet light is between 500 mJ/cm² and 1500 mJ/cm².

### Comparative Example 1

Comparative Example 1 had no optical film formed on the glass substrate with ITO conductive layer. That is to say, Comparative Example 1 was only the glass substrate with the ITO conductive layer.

### Experimental Example 2 and Comparative Examples 2 and 3

The preparation method for Experimental example 2 and comparative examples 2 and 3 was the same as that of Experimental Example 1, except that the optical coating materials of Experimental Example 2 and Comparative Examples 2 and 3 were the formulations of Experimental Example 2 and Comparative Examples 2 and 3 in Table 1, respectively.

With regard to the optical substrates prepared in Experimental Example 1 to Experimental Example 2 and Comparative Example 1 to Comparative Example 3, observing whether there was an interference pattern on the optical substrates under light irradiation, and performing tests of pencil hardness, adhesion test by cross cut for optical film on the substrate, refractive index and visible light transmittance for those optical substrates respectively. The experimental results are recorded in Table 1.

TABLE 1

| | | | | |
|---|---|---|---|---|
| Experimental | Experimental | Comparative | Comparative | Comparative |
| Example 1 | Example 2 | Example 1 | Example 2 | Example 3 |

Formulations of the optical coating material

| | | | | | |
|---|---|---|---|---|---|
| Resin 1 (wt %) | 24 | 24 | — | 24 | 24 |
| Resin 2 (wt %) | 10 | 6 | — | 20 | 10 |
| Nano- | 4 | 8 | — | 4 | 15 |
| dispersion | | | | | |
| solution (wt %) | | | | | |
| Photoinitiator | 3 | 3 | — | 3 | 3 |
| (wt %) | | | | | |
| Leveling agent | 0.4 | 0.4 | — | 0.4 | 0.4 |
| (wt %) | | | | | |
| Organic | 58.6 | 58.6 | — | 48.6 | 47.6 |
| solvent (wt %) | | | | | |

Experimental results

| | | | | | |
|---|---|---|---|---|---|
| Pencil hardness | 4H | 3H | H | 5H | 5H |
| Adhesion test | 5B | 5B | — (*) | 5B | 5B |
| Refractive index | 1.64 | 1.664 | 1.54 | 1.605 | 1.68 |
| Visible light | 89~90 | 89~90 | 86~87 | 89~90 | 77~80 |
| transmittance (%) | | | | | |
| Interference | no | no | yes | yes | no |
| pattern | | | | | |

(*): In Comparative Example 1, since there is no optical film, the adhesion test of the optical film on the substrate cannot be carried out.
Resin 1: bisphenol A bifunctional acrylate monomers, purchased from R & A CHEMICAL CORPORATION.
Resin 2: aliphatic polyurethane acrylates, purchased from Qualipoly Chemical Corporation.
Nano-dispersion solution: nano-sized zirconia dispersion solution, purchased from R & A CHEMICAL CORPORATION.

The same photoinitiator, leveling agent, and organic solvent were used in the above Experimental Examples 1-2 and Comparative Examples 2-3. The photoinitiator was purchased from Omnirad TPO, and the organic solvent was purchased from MEK.

According to the experimental results in Table 1, compared with the optical substrate of Comparative Example 1 without optical film, the optical substrates of Experimental Examples 1 and 2 with optical film on the surface of the optical substrate show good hardness, adhesiveness, refractive index, and visible light transmittance, so they can protect the interior of the optical substrate free from scratches, and avoid interference or diffraction caused by optical path difference. The optical coating material of Comparative Example 2 added more than 40% by weight of resin, resulting in a low optical film refractive index, which could not effectively reduce the interference or diffraction caused by the optical path difference. The optical coating material of Comparative Example 3 added more than 10% by weight of nano-dispersion solution, resulting in poor visible light transmittance and reduced transparency of the formed optical film.

In summary, the optical coating material of the present invention includes 15% to 40% by weight of resin, 1% to 10% by weight of nano-dispersion solution and 40% to 70% by weight of organic solvent, wherein the resin is at least one selected from a group consisting of polyurethane acrylate resin, epoxy resin, acrylate resin and acrylic polyol resin, and the nanoparticles of nano-dispersion solution include aluminum oxide, zirconium oxide, titanium oxide or silicon dioxide. Therefore, an optical film with high transparency, high hardness, high refractive index and good adhesion can be formed by the optical coating material. When the optical film is disposed in the optical substrate, since the optical film has a high refractive index, the difference in the refractive index between the optical film and the underlying material can be reduced with good optical matching, thereby avoiding the interference caused by the optical path difference and improving the quality of optical substrate.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical coating material, comprising:
15% by weight to 40% by weight of a resin, wherein the resin is at least one selected from a group consisting of a polyurethane acrylate resin, an epoxy resin, an acrylate resin and an acrylic polyol resin;
1% by weight to 10% by weight of a nano-dispersion solution, wherein the nano-dispersion solution includes nanoparticles, and the nanoparticles include aluminum oxide, zirconium oxide, titanium oxide or silicon dioxide; and
40% by weight to 70% by weight of an organic solvent.

2. The optical coating material according to claim 1, wherein the polyurethane acrylate resin comprises aliphatic polyurethane acrylates or aromatic polyurethane acrylates.

3. The optical coating material according to claim 1, wherein the epoxy resin comprises a cycloaliphatic epoxy resin or a carboxyl group epoxy resin.

4. The optical coating material according to claim 1, wherein the acrylate resin comprises bisphenol A modified acrylate resins.

5. The optical coating material according to claim 1, further comprising:
1% by weight to 10% by weight of a photoinitiator; and
0.1% by weight to 1% by weight of a leveling agent.

6. The optical coating material according to claim 1, wherein the organic solvent is selected from a group consisting of methyl ethyl ketone, propylene glycol methyl ether acetate, propylene glycol monomethyl ether, methyl isobutyl ketone, ethyl acetate and toluene.

7. An optical film formed by the optical coating material according to claim 1.

8. The optical film according to claim 7, wherein a refractive index of the optical film is between 1.63 and 1.67.

9. An optical substrate, comprising:
a substrate;
a conductive layer disposed on the substrate; and
an optical film according to claim 7 covering the conductive layer and the substrate.

10. The optical substrate according to claim 9, wherein a material of the conductive layer comprises indium tin oxide, gallium-doped zinc oxide, aluminum-doped zinc oxide or poly(3,4-ethylenedioxythiophene) polystyrene sulfonate.
